(19) United States
(12) Patent Application Publication
(10) Pub. No.: US 2005/0051727 A1
(43) Pub. Date: Mar. 10, 2005

(54) Infrared elimination system

(76) Inventors: Richard S. Jones, West Columbia, SC (US); Dale Thomas, Cleveland, GA (US)

Correspondence Address: SARA A. CENTIONI;NEXSEN PRUET, LLC, POST OFFICE DRAWER 2426, COLUMBIA, SC, 29202-2426, US

(21) Appl. No.: 10/935,204

(22) Filed: Sep. 7, 2004

Related U.S. Application Data
(60) Provisional application No. 60/500,846, filed on Sep. 5, 2003.

(51) Int. Cl. G01J 5/02

(52) U.S. Cl. 250/339.02

(57) ABSTRACT

A silicon based system that filters infrared light by using a traditional photodiode or phototransistor to sense visible and infrared light. The system then provides for a second photodiode or phototransistor which senses only infrared. The signal provided by this second, infrared-only photodiode or phototransistor is then subtracted from the first photodiode or phototransistor. The resulting signal represents only the visible portion of the spectrum.

### CROSS REFERENCE TO RELATED APPLICATIONS

The present application claims the benefit of priority of U.S. Application Ser. No. 60/500,846 filed Sep. 5, 2003.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISK APPENDIX

Not Applicable.

### BACKGROUND OF THE INVENTION

This invention relates generally to photocontrols for sensing light and turning on and off lighting.

To control lighting, such as outdoor lighting, it is generally desirable that the light sensor be sensitive to a similar wavelength spectrum as the human eye. This is defined as visible light (approximately 300 to 700 nm). Over the years, cadmium sulfide photocells have been utilized, as their wavelength response falls nicely within the visible spectrum. More recently, however, silicon photodiodes and phototransistors have been used with the added benefits of improved stability and better resistance to the outdoor environment. A disadvantage of the silicon devices for this purpose, however, is that their wavelength response goes beyond the visible spectrum and into the infrared spectrum (approximately 700 to 1200 nm). If a system has an inordinate amount of infrared present, it can influence the photocontrol such that the outdoor light will not come on at the proper time, as viewed by the human eye.

One way to solve this problem is by placing an optical infrared filter in front of the photodiode or phototransistor. There are several disadvantages to this method: Glass filters are too expensive for this purpose. Plastic filters, therefore, are used. Plastic filters fade with the effects of ultraviolet radiation. The filtering effect thus is lost with time. As this takes place, the photodiode or phototransistor's sensitivity greatly increases, causing the photocontrol's switch point to shift. Any infrared energy that reaches the phototransistor directly (not through the filter) affects the phototransistor's sensitivity.

Accordingly, there remains a need for an effective photocontrol for sensing light and turning on and off lighting that overcomes these disadvantages.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

This invention provides a silicon based system which achieves filtering of infrared by using a traditional photodiode or phototransistor to sense visible and infrared light. It then provides for a second photodiode or phototransistor which senses only infrared. The signal provided by this second, infrared-only photodiode or phototransistor is then subtracted from the first photodiode or phototransistor. The resulting signal represents only the visible portion of the spectrum.

Because the two photodiodes or phototransistors are apposing, and because the junctions of both photodiodes or phototransistors are in close physical proximity and thus are of equal temperature, this configuration also provides for temperature compensation, thus stabilizing the collector current of the circuit versus ambient temperature.

Other features and advantages of the present invention will be apparent to those skilled in the art from a careful reading of the Detailed Description of the Preferred Embodiments presented below and accompanied by the drawings.

### BRIEF DESCRIPTION OF THE DRAWINGS

In the drawings,

FIG. 1 illustrates a schematic view of a photodiode system according a preferred embodiment of the present invention.

### DETAILED DESCRIPTION OF THE PREFERRED EMBODIMENTS

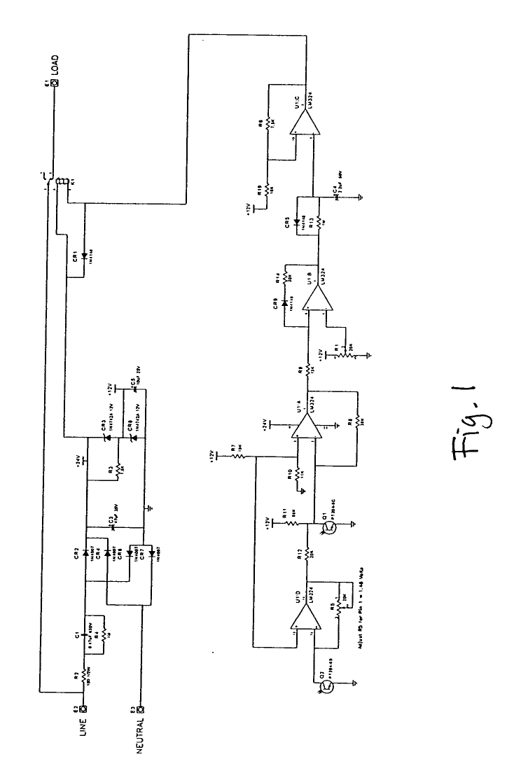

As illustrated in FIG. 1, the present invention provides a silicon based system which achieves filtering of infrared by using a traditional photodiode or phototransistor to sense visible and infrared light (a spectral response to approximately 300 to 1200 nm). Additionally, the present invention provides a second photodiode or phototransistor which senses only infrared (approximately 700 to 1200 nm). The signal provided by this second, infrared-only photodiode or phototransistor is then subtracted from the first photodiode or phototransistor. The resulting signal represents only the visible portion of the spectrum, approximately 300 to 700 nm.

Because the two photodiodes or phototransistors are apposing, and because the junctions of both photodiodes or phototransistors are in close physical proximity and thus are of equal temperature, this configuration also provides for temperature compensation, thus stabilizing the collector current of the circuit versus ambient temperature.

1. A method for filtering infrared, comprising:
providing a first photodiode for sensing visible light and infrared light, wherein said first photodiode produces a first signal;
providing a second photodiode for sensing only infrared light, wherein said second photodiode produces a second signal; and
subtracting said second signal from said first signal to produce a third signal, wherein said third signal represents only the visible portion of a light spectrum.

2. A system for filtering infrared, comprising:
a first photodiode, wherein said first photodiode produces a first signal;
a second photodiode, wherein said second photodiode produces a second signal and
means for subtracting said second signal from said first signal to produce a third signal.

3. The system as recited in claim 2, wherein said first photodiode senses visible light and infrared light.

4. The system as recited in claim 3, wherein said first photodiode senses from approximately 300 nm to approximately 1200 nm.

5. The system as recited in claim 2, wherein said second photodiode senses infrared light.

6. The system as recited in claim 5, wherein said second photodiode senses from approximately 700 nm to approximately 1200 nm.

7. The system as recited in claim 2, wherein said first photodiode and said second photodiode are apposing.

8. The system as recited in claim 2, wherein said first photodiode and said second photodiode are in close proximity.

9. The system as recited in claim 2, wherein said first photodiode and said second photodiode are of equal temperature.

10. The system as recited in claim 2, wherein said system is silicone based.
